(19) United States
(12) Patent Application Publication
(10) Pub. No.: US 2023/0084563 A1
(43) Pub. Date: Mar. 16, 2023

(54) ELECTRODE FORMULATION FOR A LI-ION BATTERY AND METHOD FOR MANUFACTURING AN ELECTRODE WITHOUT SOLVENT

(71) Applicant: Arkema France, Colombes (FR)

(72) Inventors: Stephane Bizet, Serquigny (FR); Anthony Bonnet, Colombes Cedex (FR); Oleksandr Korzhenko, Lacq (FR); Samuel Devisme, Serquigny (FR)

(21) Appl. No.: 17/795,020

(22) PCT Filed: Jan. 29, 2021
(86) PCT No.: PCT/FR2021/050166

§ 371 Date: Jul. 25, 2022

(30) Foreign Application Priority Data
Jan. 29, 2020 (FR) 2000862

(51) Int. Cl. H01M 4/62; H01M 10/0525; H01M 4/04; H01M 4/66; H01M 50/46

(52) U.S. Cl. CPC H01M 4/623; H01M 10/0525; H01M 4/625; H01M 4/0404; H01M 4/661; H01M 4/0471; H01M 50/46

(57) ABSTRACT

The present invention relates generally to the field of electrical energy storage in rechargeable secondary batteries of Li-ion type. More specifically, the invention relates to an electrode formulation for a Li-ion battery, comprising a binder based on a mixture of fluoropolymers. The invention also relates to a process for preparing electrodes using said formulation, by a technique of solvent-free deposition on a metal substrate. The invention relates finally to an electrode obtained by this process and also to Li-ion secondary batteries comprising at least one such electrode.

### FIELD OF THE INVENTION

The present invention relates generally to the field of electrical energy storage in rechargeable secondary batteries of Li-ion type. More specifically, the invention relates to an electrode formulation for a Li-ion battery, comprising a binder based on a mixture of fluoropolymers. The invention also relates to a process for preparing electrodes using said formulation, by a technique of solvent-free deposition on a metal substrate. The invention relates finally to an electrode obtained by this process and also to Li-ion secondary batteries comprising at least one such electrode.

### TECHNICAL BACKGROUND

A Li-ion battery comprises at least one negative electrode or anode coupled to a copper current collector, a positive electrode or cathode coupled to an aluminum current collector, a separator and an electrolyte. The electrolyte consists of a lithium salt, generally lithium hexafluorophosphate, mixed with a solvent that is a mixture of organic carbonates, which are selected in order to optimize ion transportation and dissociation.

Rechargeable, or secondary, batteries are more advantageous than primary batteries (which are not rechargeable) because the associated chemical reactions taking place at the positive and negative electrodes of the battery are reversible. The electrodes of the secondary cells can be regenerated multiple times by application of an electrical charge. Many advanced electrode systems have been developed for storing the electrical charge. In parallel, great efforts have been devoted to developing electrolytes capable of improving the capacities of electrochemical cells.

For their part, the electrodes generally comprise at least one current collector on which is deposited, in the form of a film, a composite material consisting of: a material termed active because it exhibits electrochemical activity toward lithium, a polymer which acts as binder, plus one or more electronically conductive additives which are generally carbon black or acetylene black, and optionally a surfactant.

Binders are counted among the so-called inactive components, because they do not contribute directly to the capacity of the cells. However, their key role in the treatment of the electrodes and their considerable influence on the electrochemical performance of electrodes have been widely described. The principal relevant physical and chemical properties of binders are: thermal stability, chemical and electrochemical stability, tensile strength (strong adhesion and cohesion) and flexibility. The main purpose of using a binder is to form stable networks of the solid components of the electrodes, that is to say the active materials and the conductive agents (cohesion). In addition, the binder must ensure close contact between the composite electrode and the current collector (adhesion).

Polyvinylidene fluoride (PVDF) is the binder most commonly used in lithium-ion batteries on account of its excellent electrochemical stability, good adhesion capacity and strong adhesion to the materials of the electrodes and of the current collectors. However, PVDF can be dissolved only in certain organic solvents such as N-methylpyrrolidone (NMP), which is volatile, flammable, explosive and highly toxic, causing serious environmental problems. The use of organic solvents requires significant investment in production, recycling and purification facilities. If the electrodes of lithium-ion batteries are produced in a solvent-free process, while complying with the same specifications, then the carbon footprint and the production costs will be considerably reduced.

The article by Wang et al. (J. Electrochem. Soc. 2019 166 (10): A2151-A2157) analyzed the influence of several properties of PVDF binders on electrodes fabricated by a dry powder coating process (electrostatic spray deposition). To improve the adhesion to the metal substrate and the cohesion of the electrode, a heat treatment step of 1 hour at 200° C. is carried out. The electrode contains 5% by weight of binder. Two binders of different viscosities are used: HSV900 (50 kpoise) and a grade from Alfa Aesar (25 kpoise).

The fluid binder results in the best adhesion but in behavior at high discharge rate which is worse than the viscous binder (capacity retention improves under these conditions, going from 17% to 50% without reducing the binding strength and the long-term cycling performance). The porosity of the binder layer increases with the molecular weight of the PVDF.

The impact of different PVDF blends on the properties of electrodes fabricated by a dry coating process was not, however, described.

Compared to the conventional method of producing electrodes in a wet suspension, dry (solvent-free) production processes are simpler; such processes eliminate the emission of volatile organic compounds and offer the possibility of producing electrodes having greater thicknesses (>120 μm), with a higher energy density in the final energy storage device. The change in the production technology will have a small impact on the active material of the electrodes, however, the polymer additives responsible for the mechanical integrity of the electrodes and the electrical behavior thereof must be suitable for the new fabrication conditions.

There is still a need to develop new electrode compositions for Li-ion batteries which are suitable for implementation without the use of organic solvents.

The objective of the invention is therefore to provide a Li-ion battery electrode composition capable of being transformed.

The invention also aims to provide a process for producing an electrode for a Li-ion battery employing said formulation, by a technique of solvent-free deposition on a metal substrate. The invention lastly relates to an electrode obtained by this process.

Finally, the invention aims to provide rechargeable Li-ion secondary batteries comprising at least one such electrode.

### SUMMARY OF THE INVENTION

The technical solution proposed by the present invention is an electrode composition for a Li-ion battery, comprising a binder based on a mixture of at least two fluoropolymers having different crystallinities.

The invention relates firstly to a Li-ion battery electrode comprising an active filler for anode or cathode, an electronically conductive filler and a fluoropolymer(-based) binder. Characteristically, said binder consists of a mixture of at least two fluoropolymers:
a fluoropolymer A which comprises at least one copolymer of vinylidene fluoride (VDF) and hexafluoropropylene (HFP) having an HFP content greater than or equal to 3% by weight, and
a fluoropolymer B which comprises at least a VDF homopolymer and/or at least one VDF-HFP copolymer, said fluoropolymer B having a weight content of HFP which is at least 3% lower than the weight content of HFP of the polymer A.

The fluoropolymer A comprises at least one VDF-HFP copolymer having an HFP content of greater than or equal to 3% by weight, preferably greater than or equal to 6%, advantageously greater than or equal to 9%.

Its weight content in the binder is greater than or equal to 1% by weight and less than or equal to 20%, preferentially greater than or equal to 5% and less than or equal to 20%.

The fluoropolymer B comprises at least one VDF-HFP copolymer having a weight content of HFP which is at least 3% lower than the weight content of HFP of the polymer A. Its weight content in the binder is less than or equal to 99% and greater than or equal to 80%; preferably, it is less than or equal to 95% and greater than or equal to 80%.

The invention also relates to a process for producing a Li-ion battery electrode, said process comprising the following operations:
mixing the active filler, the polymeric binder and the conductive filler by means of a process that makes it possible to obtain an electrode formulation that can be applied to a metal support by a “solvent-free” process;
depositing said electrode formulation on the metal substrate by a “solvent-free” process so as to obtain a Li-ion battery electrode, and
consolidating said electrode by a heat treatment and/or thermomechanical treatment.

The invention also relates to a Li-ion battery electrode produced by the process described above.

The invention also provides a Li-ion secondary battery comprising a negative electrode, a positive electrode and a separator, in which at least one electrode is as described above.

The present invention makes it possible to overcome the disadvantages of the prior art. More particularly, it provides a technology that makes it possible to:
control the distribution of the binder and of the conductive filler on the surface of the active filler;
ensure the cohesion and the mechanical integrity of the electrode by guaranteeing good film formation or consolidation of the formulations, which can be difficult to achieve for solvent-free processes;
generate adhesion on the metal substrate;
reduce the temperature of the electrode consolidation step and/or the duration of the consolidation step compared to an electrode containing a PVDF homopolymer;
improve the homogeneity of the electrode composition in the thickness and width of the electrode;
control the privacy of the electrode and ensure the homogeneity thereof in the thickness and width of the electrode;
reduce the overall content of binder in the electrode, which, in the case of the known solvent-free processes, remains greater than that of a standard slurry process;
improve the mechanical strength of self-supporting films of electrode formulations. This means that when the solvent-free electrode production process proceeds via an intermediate phase of production of a self-supporting film of the formulation prior to assembly on the current collector, the formulation makes it possible to attain mechanical behaviour sufficient for the handling and winding/unwinding phases.

The advantage of this technology is to improve the following properties of the electrode: the homogeneity of the composition in the thickness, the homogeneity of the porosity, the cohesion, and the adhesion to the metal substrate. It also allows the reduction of the content of binder needed in the electrode, and also the reduction of the heat treatment temperature and time in order to control the porosity and improve the adhesion.

### DESCRIPTION OF EMBODIMENTS OF THE INVENTION

The invention is now described in greater detail and in a nonlimiting manner in the description that follows.

According to a first aspect, the invention relates to a Li-ion battery electrode comprising an active filler for anode or cathode, an electronically conductive filler and a fluoropolymer(-based) binder. Characteristically, said binder consists of a mixture of at least two fluoropolymers:
a fluoropolymer A which comprises at least one copolymer of vinylidene fluoride (VDF) and hexafluoropropylene (HFP) having an HFP content greater than or equal to 3% by weight, and
a fluoropolymer B which comprises at least a VDF homopolymer and/or at least one VDF-HFP copolymer, said fluoropolymer B having a weight content of HFP which is at least 3% lower than the weight content of HFP of the polymer A.

According to various embodiments, said electrode comprises the features below, in combination where appropriate. The stated contents are expressed by weight, unless otherwise stated.

The fluoropolymer A comprises at least one VDF-HFP copolymer having an HFP content of greater than or equal to 3% by weight, preferably greater than or equal to 6%, advantageously greater than or equal to 9%. Said VDF-HFP copolymer has an HFP content of less than or equal to 55%, preferably less than or equal to 50%.

The VDF-HFP copolymer present in fluoropolymer A is not very crystalline. The incorporation of this copolymer into the electrode makes it possible in particular to control the degree of coverage of the surface of the active filler by the binder.

According to one embodiment, the fluoropolymer A consists of a single VDF-HFP copolymer having an HFP content of greater than or equal to 3%. According to one embodiment, the HFP content of this VDF-HFP copolymer is between 6% and 55%, limits included, preferably between 9% and 50%, limits included.

According to one embodiment, the fluoropolymer A consists of a mixture of two or more VDF-HFP copolymers, the HFP content of each copolymer being greater than or equal to 3%. According to one embodiment, each of the copolymers has an HFP content of between 6% and 55%, limits included, preferably between 9% and 50%, limits included.

The molar composition of the units in the fluoropolymers can be determined by various means, such as infrared spectroscopy or Raman spectroscopy. Conventional methods of elemental analysis of elements carbon, fluorine and chlorine or bromine or iodine, such as X-ray fluorescence spectroscopy, make it possible to calculate unambiguously the composition by weight of the polymers, from which the molar composition is deduced.

Use may also be made of multinuclear NMR techniques, notably proton (1H) and fluorine (19F) NMR techniques, by analysis of a solution of the polymer in a suitable deuterated solvent. The NMR spectrum is recorded on an FT-NMR spectrometer equipped with a multinuclear probe. The specific signals given by the various monomers in the spectra produced according to one or the other nucleus are then located.

The fluoropolymer B comprises at least one VDF-HFP copolymer having a weight content of HFP which is at least 3% lower than the weight content of HFP of the polymer A.

The combination of a low-crystallinity fluoropolymer A with a crystalline fluoropolymer in the composition of the electrode makes it possible to control the degree of coverage of the surface of the active filler by the binder. Indeed, during the electrode consolidation step, each binder has a different ability to deform and to flow between and on the surface of the active fillers under the effect of the temperature and pressure. The low-crystallinity fluorinated binder A having a lower melting point and/or being more deformable than the crystalline fluorinated binder B has a greater tendency to spread on the surface of the active fillers and thus to promote the cohesion of the electrode. This takes place at the expense of the lithium ion exchange area between the active filler and the electrolyte, which can limit the performance of the battery at high discharge rates. Also, the addition of a more crystalline and less deformable binder makes it possible to limit the coverage of the active fillers while providing cohesion to the electrode. The control of the ratio between the two binders thus allows the control of the porosity and of the cohesion of the electrode.

According to one embodiment, the fluoropolymer B is a vinylidene fluoride (VDF) homopolymer or a mixture of vinylidene fluoride homopolymers.

According to one embodiment, the fluoropolymer B consists of a single VDF-HFP copolymer. According to one embodiment, the HFP content of this VDF-HFP copolymer is between 1% and 10%, endpoints included. According to one embodiment, the HFP content of this VDF-HFP copolymer is between 1% and 15%, endpoints included.

According to one embodiment, the fluoropolymer B is a mixture of PVDF homopolymer with a VDF-HFP copolymer or else a mixture of two or more VDF-HFP copolymers.

The fluoropolymers used in the invention can be obtained by known polymerization methods, such as solution, emulsion or suspension polymerization. According to one embodiment, they are prepared by an emulsion polymerization process in the absence of a fluorinated surfactant.

According to one embodiment, said mixture contains:
i. a weight content of polymer A of greater than or equal to 1% and less than or equal to 20%, preferentially greater than or equal to 5% and less than or equal to 20%, and
ii. a weight content of polymer B of less than or equal to 99% and greater than 80%, preferably less than or equal to 95% and greater than or equal to 80%.

The active materials at the negative electrode are generally lithium metal, graphite, silicon/carbon composites, silicon, fluorographites of CFₓ type with x between 0 and 1, and titanates of LiTi₅O₁₂ type.

The materials at the positive electrode are generally of LiMO₂ type, of LiMPO₄ type, of Li₂MPO₃F type, of Li₂MSiO₄ type, where M is Co, Ni, Mn, Fe or a combination of these, of LiMn₂O₄ type or of S₈ type.

The conductive fillers are selected from carbon blacks, natural or synthetic graphites, carbon fibers, carbon nanotubes, metal fibers and powders, and conductive metal oxides. They are preferentially selected from carbon blacks, natural or synthetic graphites, carbon fibers and carbon nanotubes.

A mixture of these conductive fillers may also be produced. In particular, the use of carbon nanotubes in combination with another conductive filler such as carbon black can have the advantages of reducing the content of conductive fillers in the electrode and of reducing the content of polymer binder on account of a lower specific surface area compared to carbon black.

According to one embodiment, a polymeric dispersant that is different to said binder is used in a mixture with the conductive filler in order to break up the agglomerates present and to aid the dispersion thereof in the final formulation with the polymer binder and the active filler. The polymeric dispersant is selected from poly(vinylpyrrolidone), poly(phenylacetylene), poly(meta-phenylene vinylidene), polypyrrole, poly(para-phenylene benzobisoxazole), poly(vinyl alcohol) and mixtures thereof.

The composition by weight of the electrode is:
50% to 99% of active filler, preferably from 50% to 99%,
25% to 0.05% of conductive filler, preferably from 25% to 0.5%,
25% to 0.05% of polymer binder, preferably from 25% to 0.5%,
0 to 5% of at least one additive selected from the list: plasticizer, ionic liquid, dispersant for the conductive fillers, flow agent for the formulation, fibrillating agent such as polytetrafluoroethylene (PTFE),
   the sum of all these percentages being 100%.

The invention also relates to a process for producing a Li-ion battery electrode, said process comprising the following steps:
mixing the active filler, the polymer binder, the conductive filler and any additives by means of a process that makes it possible to obtain an electrode formulation that can be applied to a metal support by a solvent-free process;
depositing said electrode formulation on the metal substrate by a “solvent-free” process so as to obtain a Li-ion battery electrode and
consolidating said electrode by a heat treatment (application of a temperature ranging up to 50° C. above the melting temperature of the polymer, without mechanical pressure) and/or thermomechanical treatment such as calendering or thermocompression.

A “solvent-free” process is understood as meaning a process in which there is no need for a step of evaporation of residual solvent downstream of the deposition step,

Another embodiment of the process for producing an electrode comprises the following steps:
mixing the active filler, the polymeric binder and the conductive filler by means of a process that makes it possible to obtain an electrode formulation, the constituents of which are mixed homogeneously;
producing a self-supporting film of the formulation by means of a thermomechanical process such as extrusion, calendering or thermocompression;
depositing the self-supporting film on the metal substrate by a calendering or thermocompression process, and
consolidating said electrode by a heat treatment and/or thermomechanical treatment such as calendering for example, the latter step being optional if the preceding step already achieves a sufficient degree of adhesion and/or porosity.

Step of Preparing the Electrode Formulation

Polymers A and B are used in powder form, the mean particle size of which is between 10 nm and 1 mm, preferentially between 50 nm and 500 μm and even more preferentially between 50 nm and 50 μm.

The fluoropolymer powder may be obtained by various processes. The powder may be obtained directly by an emulsion or suspension synthetic process by drying by spray drying or by freeze drying. The powder may also be obtained by milling techniques, such as cryomilling. On completion of the powder production step, the particle size can be adjusted and optimized by selection or screening methods.

According to one embodiment, the polymers A and B are introduced at the same time as the active and conductive fillers at the time of the mixing step.

According to another embodiment, the polymers A and B are mixed together before mixing with the active and conductive fillers. For example, a mixture of polymers A and B can be produced by co-spraying of the latices of polymers A and B to obtain a mixture in powder form. The mixture thus obtained can, in turn, be mixed with the active and conductive fillers.

Another embodiment of the mixing step consists in proceeding in two stages. Firstly, either polymer A or polymer B or both are mixed with a conductive filler by a solvent-free process or by co-spraying. This step makes it possible to obtain an intimate mixture of the binder and the conductive filler. Then, in a second stage, the binder and the conductive filler, which have been premixed, and the optional fluoropolymer not yet used are mixed with the active filler. The mixing of the active filler with said intimate mixture is carried out using a solvent-free mixing process, to obtain an electrode formulation.

Another embodiment of the mixing step consists in proceeding in two stages. First, either polymer A or polymer B or both are mixed with an active filler by a solvent-free process or a process of spraying a liquid containing the binder and/or the conductive filler onto a fluidized powder bed of the active filler. This step makes it possible to obtain an intimate mixture of the binder and the active filler. Then, in a second stage, the binder, the active filler and the optional optional fluoropolymer not yet used are mixed with the conductive filler.

Another embodiment of the mixing step consists in proceeding in two stages. Firstly, an active filler is mixed with a conductive filler by a solvent-free process. Then, in a second stage, either the two polymers A and B are mixed at the same time with the premixed active filler and conductive filler, or the polymers A and B are mixed one after the other with the premixed active filler and conductive filler.

Solvent-free mixing processes for the various constituents of the electrode formulation include, without this being an exhaustive list: mixing by agitation, air-jet mixing, high-shear mixing, mixing with a V-mixer, mixing with a screw mixer, double-cone mixing, drum mixing, conical mixing, double Z-arm mixing, mixing in a fluidized bed, mixing in a planetary mixer, mixing by mechanofusion, mixing by extrusion, mixing by calendering, mixing by milling.

Other mixing processes include mixing options that employ a liquid such as water, for example spray drying (co-spraying) or a process of spraying a liquid containing the binder and/or the conductive filler onto a fluidized powder bed of the active filler.

At the end of this mixing step, the formulation obtained may undergo a final step of milling and/or screening and/or selection in order to optimize the size of the particles of the formulation in preparation for the step of deposition on the metal substrate.

The formulation in powder form is characterized by the bulk density. It is known in the art that low-density formulations are very restrictive in terms of the uses and applications thereof. The main components contributing to the increase in density are carbon-based additives such as carbon black (bulk density of less than 0.4 g/cm³), carbon nanotubes (bulk density of less than 0.1 g/cm³), polymer powders (bulk density of less than 0.9 g/cm³). A combination of the low-density components in order to obtain an additive combining polymer binder/electron conductor/other additive is recommended in order to improve the premixing step downstream of the deposition of the formulation described above. Such a combination can be produced by the following methods:
a) dispersion of the components in water or the organic solvent, followed by elimination of the solvent (co-spraying, freeze-drying, extrusion/compounding in the presence of the solvent or of water);
b) dry or “wet” co-milling using a known milling method such as a ball or bead mill, followed by a drying step if necessary.
   Such a method is particularly advantageous for the significant increase of the bulk density.

Step of Depositing Said Electrode Formulation on a Support

According to one embodiment, the end of the mixing step, the electrode is manufactured by means of a solvent-free powder coating method, by depositing the formulation on the metal substrate by a process of pneumatic spraying, electrostatic spraying, dipping in a fluidized powder bed, dusting, electrostatic transfer, deposition with rotary brushes, deposition with rotary metering rolls, calendering.

According to one embodiment, at the end of the mixing step, the electrode is manufactured by a two-step solvent-free powder coating process. A first step is carried out which consists in producing a self-supporting film from the premixed formulation by means of a thermomechanical process such as extrusion, calendering or thermocompression. Then this self-supporting film is assembled with the metal substrate by a process combining temperature and pressure such as calendering or thermocompression.

The metal supports of the electrodes are generally made of aluminium for the cathode and of copper for the anode. The metal supports may be surface-treated and have a conductive primer with a thickness of 5 μm or more. The supports may also be carbon fiber woven or nonwoven fabrics.

Step of Consolidating the Electrode

The consolidation of said electrode is effected by a heat treatment, by passage through an oven, under an infrared lamp, through a calender with heated rollers or through a press with heated plates. Another alternative consists of a two-step process.

First of all, the electrode is subjected to a heat treatment in an oven, under an infrared lamp or by contact with heated plates without pressure. A step of compression at ambient or elevated temperature is then carried out by means of a calender or a plate press. This step makes it possible to adjust the porosity of the electrode and to improve adhesion on the metal substrate.

The invention also relates to a Li-ion battery electrode produced by the process described above.

According to one embodiment, said electrode is an anode.

According to one embodiment, said electrode is a cathode.

The invention also provides a Li-ion secondary battery comprising a negative electrode, a positive electrode and a separator, in which at least one electrode is as described above.

### EXAMPLES

The following examples illustrate the scope of the invention in a non-limiting manner.

### Products:

PVDF 1: Vinylidene fluoride homopolymer, characterized by a melt viscosity of 2500 Pa·s at 100 s⁻¹ and 230° C.
PVDF 2: Vinylidene fluoride homopolymer, characterized by a melt viscosity of 2600 Pa·s at 100 s⁻¹ and 230° C.
PVDF 3: Copolymer of vinylidene fluoride (VDF) and of vinylidene hexafluoride (HFP) containing 12% by weight of HFP, characterized by a melt viscosity of 2500 Pa·s at 100 s⁻¹ and 230° C.
PVDF 4: Copolymer of vinylidene fluoride (VDF) and of vinylidene hexafluoride (HFP) containing 25% by weight of HFP, characterized by a melt viscosity of 1800 Pa·s at 100 s⁻¹ and 230° C.
Graphite C-NERGY ACTILION GHDR 15-4: Graphite sold by the company IMERYS characterized by a volume-average diameter (Dv50) of 17 μm and a BET specific surface area of 4.1 m²/g.

### Preparation of the Mixtures of Fluoropolymers and Graphite:

Mixtures of fluoropolymers with graphite, composed of 5% by weight of PVDF and 95% by weight of graphite, were produced by the dry process using a Minimix mixer sold by the company MERRIS International. A mixture of 50 grams of each formulation was prepared in a 250 ml metal jar by shaking in the blender for one minute and thirty seconds at room temperature.

### Preparation of the Electrodes

For the manufacture of the electrodes, each fluoropolymer/graphite mixture was manually sprinkled on the surface of an 18 μm thick copper current collector sold by the company Hohsen Corp. The mass per unit area of the deposit produced is 30 mg/cm² approximately over a surface area of 5×5 cm². At the end of the deposition, the electrodes were consolidated under a hot platen press by positioning a silicone paper between the deposited coating and the upper platen of the press. Each coating was pressed at 205° C. at 6 bar for 10 minutes. At the end of this pressing phase, the electrodes were removed from the press and left to cool to room temperature. Then the silicone paper was removed.

### Evaluation of the Electrodes

The objective of the manufacturing process is to obtain a coating of around one hundred microns on a metal support which has sufficient cohesion to allow the electrodes to be handled without the coating cracking or splitting. The first thing to check is therefore the ability of the formulation to form a cohesive and homogeneous coating at the surface of the current collector. An indicator of this degree of consolidation is the amount of powder/formulation which is transferred and remains attached to the surface of the silicone paper at the end of the pressing phase. A coating is judged to have good film formation and consolidation within the context of the protocol described if no fragment of coating remains attached to the silicone paper.
Another criterion of good mechanical integrity is the degree of adhesion obtained on the collector, any spontaneous delamination of the coating having to be avoided.
Table 1 illustrates the composition of the PVDFs used in the examples according to the invention.

TABLE 1

| | Example | Comparative | Comparative |
|---|---|---|---|
| | 1 | Example 1 | Example 2 |
| PVDF 1 | 80 | 100 | |
| PVDF 2 | | | 75 |
| PVDF 3 | 20 | | |
| PVDF 4 | | | 25 |

Table 2 illustrates the properties of electrodes, the composition of which is 95% by weight of graphite and 5% by weight of PVDF.

TABLE 2

| | | Comparative | Comparative |
|---|---|---|---|
| | Example 1 | Example 1 | Example 2 |
| Film | Good - no | Good - no | Very poor - |
| formation/ | transfer observed | transfer observed | significant |
| consolidation | on the silicone | on the silicone | transfer observed |
| | paper after | paper after | on the silicone |
| | pressing | pressing | paper after |
| | | | pressing |
| Adhesion | OK - No | Insufficient - | Not possible to |
| | spontaneous | spontaneous | assess due to poor |
| | delamination | delamination | film formation |

1. A Li-ion battery electrode comprising an active filler for anode or cathode, an electronically conductive filler and a fluoropolymer binder, characterized in that said binder consists of a mixture consisting of:
a fluoropolymer A which comprises at least one copolymer of vinylidene fluoride (VDF) and hexafluoropropylene (HFP) having an HFP content greater than or equal to 3% by weight, and
a fluoropolymer B which comprises at least one VDF homopolymer and/or at least one VDF-HFP copolymer, said fluoropolymer B having a weight content of HFP which is at least 3% lower than the weight content of HFP of the polymer A.

2. The electrode of claim 1, wherein the HFP content in said at least one copolymer of vinylidene fluoride (VDF) and hexafluoropropylene (HFP) of said fluoropolymer A is greater than or equal to 6% and less than or equal to 55% by weight.

3. The electrode of claim 1, wherein the fluoropolymer A consists of a copolymer of vinylidene fluoride (VDF) and hexafluoropropylene (HFP) having an HFP content of greater than or equal to 3%.

4. The electrode of claim 1, wherein the fluoropolymer A consists of a mixture of two or more copolymers of vinylidene fluoride (VDF) and hexafluoropropylene (HFP), the HFP content of each copolymer being greater than or equal to 3%.

5. The electrode of claim 1, wherein the fluoropolymer B is a homopolymer of vinylidene fluoride.

6. The electrode of claim 1, wherein the fluoropolymer B consists of a VDF-HFP copolymer having an HFP content of between 1% and 10%.

7. The electrode of claim 1, wherein said mixture comprises:
i. a weight content of fluoropolymer A of greater than or equal to 1% and less than or equal to 20%, and
ii. a weight content of fluoropolymer B of less than or equal to 99% and greater than 80%.

8. The electrode of claim 1, wherein said active filler is selected from the group of lithium metal, graphite, silicon/carbon composites, silicon, graphene, fluorographites of CFx type where x is between 0 and 1 and titanates of LiTi₅O₁₂.

9. The electrode of claim 1, wherein said active filler is selected from the group of active materials of LiMO₂ type, LiMPO₄ type, Li₂MPO₃F type, Li₂MSiO₄ type, where M is Co, Ni, Mn, Fe or a combination of these, LiMn₂O₄ type and S₈ type.

10. The electrode of claim 1, wherein the conductive fillers are selected from carbon blacks, natural or synthetic graphites, carbon fibers, carbon nanotubes, metal fibers and powders, conductive metal oxides, and mixtures thereof.

11. The electrode of claim 1, having the following composition by weight:
50% to 99% of active filler,
0.05% to 25% of conductive filler,
0.05% to 25% of polymer binder,
0 to 5% of at least one additive selected from the list: plasticizer, ionic liquid, dispersant for the fillers, flow agent for the formulation, fibrillating agent,
the sum of all these percentages being 100%.

12. A process for producing the Li-ion battery electrode of claim 1, said process comprising the following steps:
mixing the active filler, the fluoropolymer binder and the electronically conductive filler by means of a process which makes it possible to obtain an electrode formulation that can be applied to a metal substrate by a solvent-free process;
depositing said electrode formulation on the metal substrate by a solvent-free process so as to obtain a Li-ion battery electrode, and
consolidating said electrode by a heat treatment and/or thermomechanical treatment.

13. The process of claim 12, wherein the mixing step is carried out in two stages:
mixing the electronically conductive filler and the fluoropolymer binder using a solvent-free process or by co-spraying, to obtain an intimate mixture, then
mixing the active filler with said intimate mixture using a solvent-free mixing process, to obtain an electrode formulation.

14. The process of claim 12, wherein said mixing step is carried out by a process selected from the group of: agitation, air-jet mixing, milling of the mixture, high-shear mixing, mixing with a V-mixer, mixing with a screw mixer, double-cone mixing, drum mixing, conical mixing, double Z-arm mixing, mixing in a fluidized bed, in a planetary mixer, extrusion, calendering, or mechanofusion.

15. The process of claim 12, wherein said solvent-free process is carried out by depositing the electrode formulation on the metal substrate by a process selected from the following processes: pneumatic spraying, electrostatic spraying, dipping in a fluidized powder bed, dusting, electrostatic transfer, deposition with rotary brushes, deposition with rotary metering rolls, and calendering.

16. The process of claim 12, wherein said solvent-free process is carried out in two steps: a first step which comprises producing a self-supporting film from the electrode formulation, and a second step in which the self-supporting film is assembled with the metal substrate.

17. The process of claim 12, wherein the consolidation of said electrode is carried out by at least one heat treatment selected from the group of passing through an oven, under an infrared lamp and through a calender with heated rolls.

18. A secondary Li-ion battery comprising an anode, a cathode and a separator, wherein at least one of the anode or cathode comprises the composition of claim 1.
